(19) United States
(12) Patent Application Publication
(10) Pub. No.: US 2014/0332155 A1
(43) Pub. Date: Nov. 13, 2014

(54) Method for Connecting a Connector Coupling to a Fluid Line

(71) Applicant: TI Automotive (Fuldabrück) GmbH, Fuldabruck (DE)

(72) Inventors: Iris Barthel, Schauenburg (DE); Hans Jensen, Dettingen unter Teck (DE)

(21) Appl. No.: 14/270,549

(22) Filed: May 6, 2014

(30) Foreign Application Priority Data
May 7, 2013 (EP) 13 166 901.2

(51) Int. Cl. B29C 65/36

(52) U.S. Cl. CPC B29C 65/36
USPC 156/272.4

(57) ABSTRACT

A method for connecting a connector coupling to a fluid conducting line, wherein the line consists of plastic. A line end of the line is inserted in a receiving receptacle encompassing the circumference of the connector coupling. At least one metal element is disposed in or on the receiving receptacle. The metal element is heated by means of electromagnetic induction, and, as a result of this heating, at least the plastic regions of the line end melt, such that the line end is welded to the wall, or walls, of the receiving receptacle.

### CROSS-REFERENCE TO RELATED APPLICATIONS

This patent application claims priority pursuant to Title 35 USC Section 119 to European Patent Application No. 13 166 901.2, filed May 7, 2013, the entire contents of which are hereby incorporated by reference herein.

### BACKGROUND

The invention concerns a method for connecting a connector coupling body to a fluid line, or system, particularly for a motor vehicle wherein the fluid line consists of plastic, or substantially consists of plastic. The assembly according to the invention, consisting of the connector coupling and the fluid conducting motor vehicle line, is provided in particular for conducting a fuel for an internal combustion engine of a motor vehicle. Fundamentally, the assembly according to the invention can also be used for conducting a urea solution, or an aqueous urea solution in the framework of a catalytic converter system of a motor vehicle.

Methods of the type specified above are known in the field in various embodiments. The problem exists with the assemblies consisting of connector couplings and lines created with these known methods that the ends of the lines are subject to damage or disadvantageous influences. Particularly with multi-layered lines, there is the problem of delamination of the layers. Furthermore, the ends of the lines are frequently not sufficiently protected from chemical influences, such as the effects of salt solutions and the like. The methods known so far for connecting connector couplings with a fluid conducting motor vehicle line need improving.

In this respect, the invention addresses the technical problem of providing a method of the type specified above, with which the disadvantages described above are effectively and reliably prevented.

### SUMMARY OF THE INVENTION

In order to solve this technical problem, the invention teaches a method for connecting a connector coupling to a fluid conducting motor vehicle line, wherein the line is made of plastic, or substantially made of plastic, wherein an end of the line is inserted in a receiving receptacle of the connector coupling, encompassing the circumference of the connector coupling, wherein the wall, or the walls, respectively, of the receiving receptacle preferably consist at least in part of plastic, wherein at least one conductive element is disposed in or on the receiving receptacle, wherein the conductive element is heated by means of electro-magnetic induction, and wherein at least one plastic region of the line end melts as a result of this heating, such that the line end is welded to the wall or walls of the receiving receptacle. The conductive element is particularly preferably an electrical conductor. By way of example, the conductive element is a metal element or a conducting element substantially consisting of an electro-conductive plastic.

A fluid conducting motor vehicle line means, in particular, a line for conducting a fluid medium, particularly for conducting fuel in motor vehicles. Fundamentally, however, the motor vehicle line could also be used for conducting a urea solution, or an aqueous urea solution, respectively. In the following description, instead of the term motor vehicle line, the term “line” will simply be used. It is within the scope of the invention that the fluid medium, or the liquid medium, respectively, is conducted through the line and the connector coupling. It is furthermore within the scope of the invention that the connector coupling has an inner channel for this, for conducting the fluid medium. It is recommended that the connector coupling is provided for connecting a further line or for connecting an assembly, such as a tank or the like. Preferably, the connector coupling concerns a so-called quick connector.

Within the scope of the invention, the wall, or coaxial walls, respectively, of the receiving receptacle comprise walls, or inner and outer coaxial walls, respectively, facing the line end received therein. For practical purposes, the outer wall and/or the inner wall of the line end lies directly on the wall or walls, respectively, of the receiving receptacle. The connection of the line end to the wall or walls of the receiving receptacle is obtained according to the invention by means of induction welding. For practical purposes, a typical induction device, or an induction device known from the prior art, is used for generating the induction welded connection. It is recommended that induction impulses, at least partially surrounding at least one of the connector couplings, are used for this. The induction welding occurs by means of an electromagnetic alternating field, which is implemented, for practical purposes, by means of radio waves.

According to a particularly preferred embodiment of the invention, the motor vehicle line is designed as a multi-layered line. It is recommended that the outer layer and/or the inner layer of the multi-layered line consists of plastic. It is within the scope of the invention that this concerns a plastic that can be welded by means of induction welding methods. For practical purposes, the heat required for welding the line is obtained in the induction welding process through the conductive element. Fundamentally, one layer, or one inner layer, respectively, of the multi-layered line can also be designed as a metal layer, or the like.

According to a recommended embodiment of the invention, the outer layer of the line consists of at least one polymer from the group, “polyamide, polyphenylene sulfide, polyphthalamide.” It is within the scope of the invention that the outer layer of the line ensures the mechanical strength or stability of the line. According to a particularly preferred embodiment of the invention, the outer layer of the line consists of a polyamide. A recommended embodiment of the invention is characterized in that the inner layer of the line consists of a polymer from the group, “polyamide, fluoropolymer, polyphenylene sulfide, polybutylene naphthalate.” According to one embodiment variation of the invention, the inner layer of the motor vehicle line is designed to be electro-conductive. For this, conductive additives, such as conductive carbon black and the like, are added to the material, or plastic, of the inner layer.

It is within the scope of the invention that the walls of the receiving receptacle of the connector coupling preferably consist of fiber-reinforced plastic. It is possible for the walls to consist, or substantially consist, of fiber-reinforced polyamide or polyphthalamide. Substantially consisting means here that the walls of the receiving receptacle consist of at least 80% by weight, or at least 90% by weight, respectively, of the preferably fiber-reinforced plastic, or of preferably fiber-reinforced polyamide, or possibly fiber-reinforced polyphthalamide. For practical purposes, glass fibers are used for the fiber-reinforcement.

Preferably, the line has a circular cross-section, and the receiving receptacle is preferably cylindrical, or has a circular cross-section. Fundamentally, it is within the scope of the invention, however, that other cross-sections are possible for the line or the receiving receptacle, respectively.

It is within the scope of the invention that an electro-conductive conductive element is used for the method according to the invention. This conductive element can be made of copper, steel or a similar metal. It is particularly preferred that the metal, from which the conductive element is made, exhibits a lower conductivity than copper. According to a particularly preferred embodiment of the invention, the at least one conductive element runs over the circumference of the connector coupling, or over the circumference of the receiving receptacle, respectively. For practical purposes, the at least one conductive element is ring-shaped, or cylindrical, respectively, and has a circular cross-section. A particularly recommended embodiment of the invention is characterized in that the at least one conductive element is disposed with the stipulation that the line end lies with its end surface against the at least one metal element when inserted in the receiving receptacle. As a result, for practical purposes, a melting of the plastic of the line end occurs in the region of its end surface. It is within the scope of the invention that the line end of a preferably multi-layered line is melted at its end surface, at least in the outer layer and/or in the inner layer, such that the line end is welded to the wall or walls, respectively, of the receiving receptacle.

It is recommended that the inner walls and/or outer walls of the receiving receptacle of the connector coupling are melted, at least in part, such that the line end is welded to the inner wall and/or outer wall of the receiving receptacle. For practical purposes, both the line end, or end surface of the line end, respectively, and the inner wall and/or outer wall of the receiving receptacle are melted, at least in part, such that a material bonded welding or connection between the line end and the receiving receptacle of the connector coupling can be produced.

It is within the scope of the invention that the line end of the motor vehicle line is inserted in a form-locking manner, in particular, without play, in the receiving receptacle. Without play, in this case, means that in the region where the line end is in contact with the wall or walls, respectively, of the receiving receptacle, there is no empty space, or very little empty space. According to a preferred embodiment of the invention, the length of the receiving receptacle is at least 25%, preferably at least 20% of the length of the connector. The term “length” relates thereby to the longitudinal central axis of the connector coupling and the associated motor vehicle line.

The invention is based on the knowledge that, with the method according to the invention, a very stable and reliable connection between the connector coupling and line can be created. In particular, the line, or the line end, respectively, can be effectively protected by means of this connection from mechanical damage or suchlike. The possibility of a delamination of a multi-layered line can more or less be eliminated in the production of a connection according to the invention. The line ends of the lines that are to be connected can also be effectively protected from corrosive or chemical influences, such as the effects of salt solutions or the like. The method according to the invention can also be carried out at lower costs. Another advantage of the method according to the invention is that, with the welding process, a contamination of the flow channel in the line is avoided.

### DESCRIPTION OF THE DRAWINGS

The invention shall be explained in greater detail below, based drawings depicting a single embodiment, wherein:

FIG. 1 is a connection produced according to the method according to the invention, between a connector coupling and a line end, in a cutaway view, and

FIG. 2 is the subject matter in FIG. 1, in a different functional state.

### DETAILED DESCRIPTION OF THE ILLUSTRATED EMBODIMENT

The figures illustrate the method according to the invention for connecting a connector coupling 1 to a fluid conducting motor vehicle line 2. The connector coupling 1 can concern a so-called quick connector in the embodiment example. The motor vehicle line 2 consists of plastic, and is preferably, and in the embodiment example, designed as a multi-layered line 2. In the embodiment example, the line 2 has three layers 3, 4, 5. Both the outer layer 3 as well as the inner layer 5 of the multi-layered line 2 may consist of a polyamide in the embodiment example.

According to the invention, the line end 6 of the line 2 is inserted in a receiving receptacle 7, encompassing the circumference of the connector coupling 1. The figures show the already inserted state of the line end 6. Preferably, and in the embodiment example, the receiving receptacle 7, or the walls 8, 9 of the receiving receptacle 7, respectively, consist of plastic, and according to a recommended embodiment, consist of polyamide. For practical purposes, the line 2 has a circular cross-section, and preferably, the receiving receptacle 7 is cylindrical, or has a circular cross-section, respectively. The line 2 is preferably, and in the embodiment example, accommodated in the receiving receptacle 7 of the connector coupling 1 in a form-locking manner, preferably without play.

For practical purposes, and in the embodiment example, a ring-shaped metal element 10 is disposed on the end of the receiving receptacle 7, running over the circumference of the connector coupling 1. The conductive element, designed as a metal element 10, can be made of steel in the embodiment example. The line end 6 rests against the metal element 10 at its end surface in the state depicted in the figures, when inserted in the receiving receptacle 7.

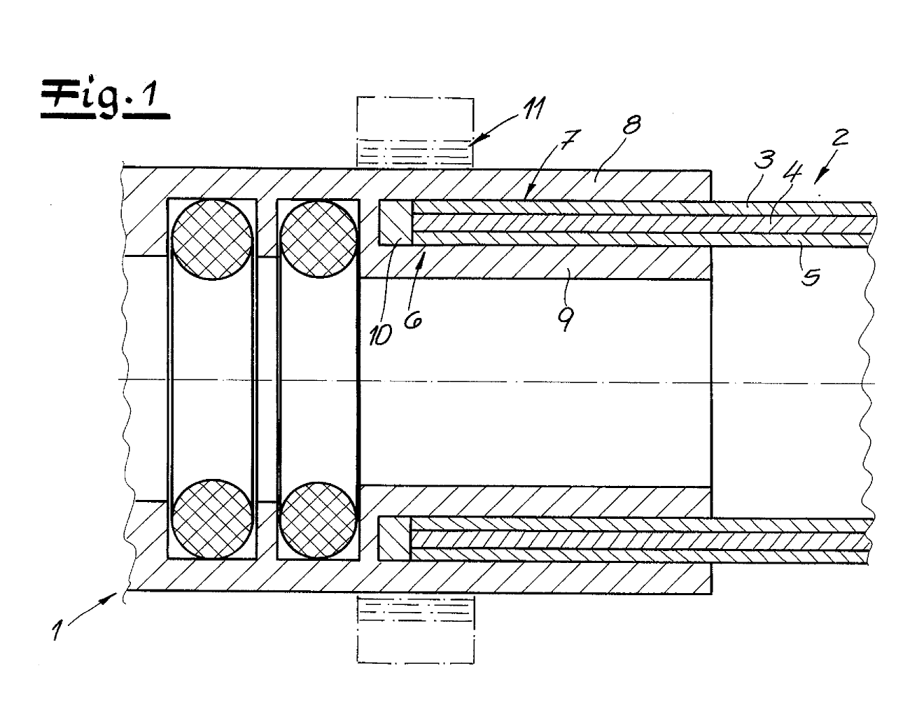

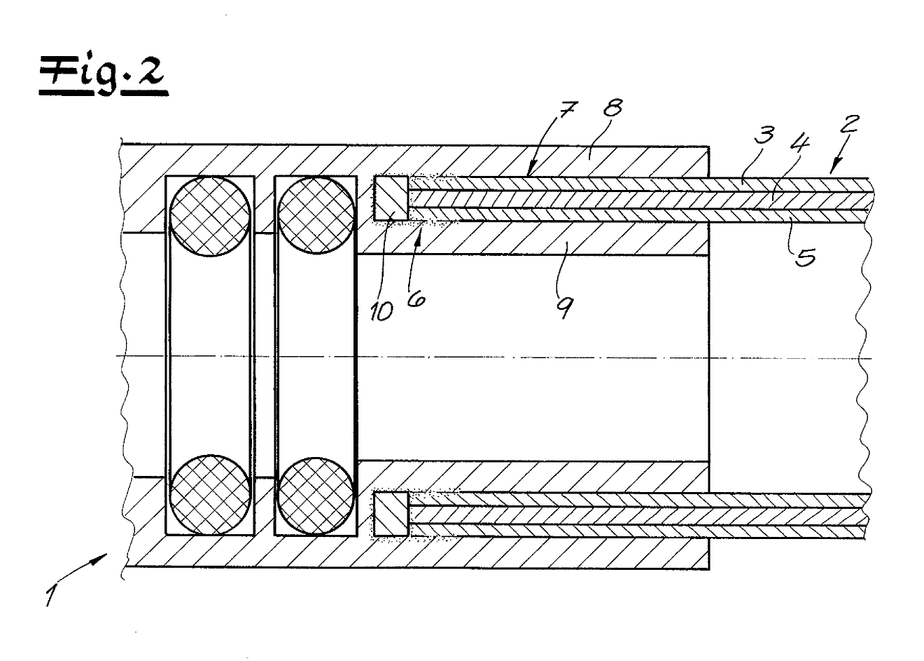

According to the invention, the metal element 10 is heated by means of electromagnetic induction. For this, an electromagnetic alternating field 11 is generated in the region of the metal element 10, which is schematically depicted in FIG. 1. The plastic regions of the line end 6 at the end surface of the line end 6 are melted as a result of the heating. Preferably, and in the embodiment example, the plastic regions of the walls 8, 9 of the receiving receptacle 7 are also melted. As a result, the line end is welded to the walls 8, 9 of the receiving receptacle 7 of the connector coupling 1. According to the invention, an induction welding thus occurs, and as a result, the line end 6 of the line 2 is bonded, or welded, respectively, in a material bonding manner to the walls 8, 9 of the receiving receptacle 7 of the connector coupling 1. FIG. 2 shows the welded state of the assembly consisting of the connector coupling 1 and the line 2.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The claims are to be construed to include alternative embodiments to the extent permitted by the prior art.

1. A method for connecting a connector coupling to a fluid conducting line, wherein the line is made of plastic, wherein a line end of the line is inserted in a receiving receptacle of the connector coupling, which encompasses the circumference of the connector coupling, wherein, preferably, the wall, or walls, of the receiving receptacle consist, at least in part, of plastic, wherein at least one conductive element is disposed in or on the receiving receptacle, wherein the conductive element is heated by means of electromagnetic induction, and wherein, as a result of this heating, at least the plastic regions of the line end melt, such that the line end is welded to the wall, or walls of the receiving receptacle.

2. The method according to claim 1, wherein the line is a multi-layered line, and wherein the outer layer and/or the inner layer of the line consists of plastic.

3. The method according to claim 1, wherein the outer layer of the line consists of at least one polymer from the group, consisting of polyamide, polyphenylene sulfide, and polyphthalamide.

4. The method according to claim 1, wherein the inner layer of the line consists of at least one polymer from the group, consisting of polyamide, fluoropolymer, polyphenylene sulfide, and polybutylene naphthalate.

5. The method according to claim 1, wherein the walls of the receiving receptacle of the connector coupling consist of plastic, preferably polyamide or polyphthalamide.

6. The method according to claim 1, wherein the line has a circular cross-section design, and wherein the receiving receptacle has a cylindrical or a circular cross-section.

7. The method according to claim 1, wherein the conductive element encompasses the circumference of the connector coupling, or the receiving receptacle, respectively.

8. The method according to claims 1, wherein the conductive element is disposed such that the line end rests against the metal element at its end surface, when in the inserted state.

9. The method according to claim 8, wherein the line end is melted, at least at its end surface, at least in the outer layer and/or the inner layer, such that the line end is welded to the wall, or walls of the receiving receptacle.

10. The method according to claim 1, wherein the inner wall and/or the outer wall of the receiving receptacle of the connector coupling are melted, at least in part, such that the line end is welded to the wall, or walls of the receiving receptacle.

11. The method according to claim 1, wherein the line end is inserted in the receiving receptacle in a form-locking manner, and particularly, without play.

12. The method according to claim 1, wherein the length of the receiving receptacle is at least 25%, preferably at least 20%, of the length of the connector coupling.
